(19) United States
(12) Patent Application Publication
(10) Pub. No.: US 2005/0223839 A1
(43) Pub. Date: Oct. 13, 2005

(54) Modified manual control lever devices and methods

(76) Inventor: Richard W. Crabtree, Casper, WY (US)

Correspondence Address: THE LAW FIRM OF HARRIS & BURDICK;HAROLD BURDICK AND ROBERT HARRIS, 6676 GUNPARK DRIVE, SUITE E, BOULDER, CO, 80301, US

(21) Appl. No.: 10/822,203

(22) Filed: Apr. 12, 2004

(51) Int. Cl. G05G 11/00

(52) U.S. Cl. 74/502.2

(57) ABSTRACT

Modified manual control lever devices and methods for use with motorized vehicles having handlebar-type steering mechanisms including a handle grip are disclosed. The devices include a main body having at least one flare (a lateral surface extension) extending from a body portion. Two flares are preferred each extending from the body portion opposite one another. The length of the flares is selected so that a distal end of the control lever remains prominent and readily manually engageable. The flares are configured on the main body to extend, in use, in a direction substantially normal to the plane of control lever movement.

### FIELD OF THE INVENTION

This invention relates to hand operated control levers utilized on various types of motorized vehicles having handlebar-type steering, and, more particularly, relates to control levers and lever attachments mounted adjacent to the handle grip of such vehicles.

### BACKGROUND OF THE INVENTION

Control levers (such as brake, shifting and throttle levers, for example) are in wide use on a variety of motorized vehicles including snowmobiles, personal watercraft, all terrain vehicles, motorcycles, motorbikes, scooters and the like. Such levers are operable by engagement of an accessible surface area (manually—often by the user's thumb or fingers—causing pivoting movement thereof toward the hand grip of the handlebar-type steering common to such vehicles) to perform critical vehicle control functions during vehicle operation.

Heretofore known control levers are maintained (mounted) in an orientation relative to the vehicle's hand grip(s) adequate to provide manual access to the accessible surface area of the lever for operation thereof when the user is in a defined body position (typically seated on the vehicle between the hand grips). However, different riding conditions encountered and riding styles utilized by operators on such vehicles require, in many cases, frequent and repeated shifting of body position relative to the vehicle during operation, including, for example, standing (on pegs, platforms or the like), sitting, and leaning laterally, forward and/or back. These movements make engagement of the user's hand or digits with the accessible surface area of the control levers difficult in positions other than the defined body position.

Extenders for such control levers have been heretofore suggested and or utilized. Such heretofore known extenders have addressed lever lengthening (see U.S. Pat. No. 6,494,113) or wind/cold shielding (see U.S. Pat. No. 4,838,113), but have not addressed adequately the problem of lever access from a variety of user hand positions and/or angles. Modified throttle assemblies allowing throttle lever position change, multi-directional operability or the like have been heretofore suggested and or utilized (see U.S. Patent Application Publication Nos. U.S. 2002/0026849 A1 and U.S. 2001/0045141 A1), but are unduly complex (and therefore expensive to implement) and/or require extensive equipment modification, rider retraining or the like. The use of added actuator mechanisms for use in combination with existing control levers to perform control lever functions from different attack angles has been suggested (see U.S. Pat. Nos. 6,658,965, 6,167,776, 5,775,167 and 4,619,341). The addition of more control levers on handlebar-type steering assemblies, however, unduly complicates the use of vehicle control mechanisms and crowds the handle grip area. Further development is therefore needed.

### SUMMARY OF THE INVENTION

This invention provides devices and methods for improving accessibility of vehicle control levers (such as throttle levers and the like) utilized on motor vehicles having handlebar-type steering assemblies including handle grips (such as snowmobiles, for example), to accommodate different riding conditions encountered and riding styles utilized by operators of such vehicles. Such control levers typically have a distal end and are movable toward and away from the handle grip in a plane defined between the handle grip and the throttle lever. The devices are adapted to improve control lever access from a variety of different user hand positions and/or angles resulting from different user body positions relative to the lever. The devices of this invention are simple to apply and utilize, are inexpensive to implement, require little original equipment modification or rider retraining, and leave the handle grip area uncluttered.

The device may be original equipment on the vehicle, a replacement control lever (pivoting lever only, not necessarily including the body), or a modification attachment for application at an existing control lever, the devices in any case effectively modifying the manually accessible surface area of the control lever.

The manually engageable control lever device of this invention includes a main body mountable at existing structure on the vehicle and adjacent to the vehicle handle grip. The main body has at least one flare (and preferably two) extending therefrom adapted for secure engagement by either a user's finger or thumb to cause movement from a variety of user hand positions or angles at the handle grip once the main body is mounted. The main body is configured so that upon mounting the flare is oriented convergently relative to the handle grip, with a substantial but variable space defined between the flare and the handle grip during operation of the device.

The main body includes a portion (a central portion in the case of a device having two flares) from which the flare extends. In the case of the modification attachment embodiment of this invention, the portion of the main body is contoured to fit the control lever so that the flare extends in a direction substantially normal to the plane of control lever movement once the main body is attached to the throttle lever.

The method of this invention is directed to modification of a digitally accessible surface of a manual control lever for a vehicle having handlebar-type steering that includes at least one handle grip, the lever having a distal end and movable, when mounted, toward and away from the handle grip in a plane defined between the handle grip and the control lever. The method steps include defining at least first and second areas of the digitally accessible surface of the control lever and extending at least one of the areas of the digitally engagable surface of the control lever in a direction substantially normal to the plane of control lever movement.

It is therefore an object of this invention to provide modified manual control lever devices and methods.

It is another object of this invention to provide devices and methods for improving accessibility of control levers for motor vehicles having handlebar-type steering assemblies including handle grips.

It is another object of this invention to provide devices and methods for improving accessibility of control levers for motor vehicles to accommodate different riding conditions encountered and riding styles utilized by operators of such vehicles.

It is still another object of this invention to provide devices and methods adapted to improve motor vehicle control lever access from a variety of different user hand positions and/or angles resulting from different user body positions relative to the lever.

It is yet another object of this invention to provide devices for improving accessibility of manual control levers for motor vehicles that are simple to apply and utilize, are inexpensive to implement, require little original equipment modification or rider retraining, and leave the handle grip area uncluttered.

It is another object of this invention to provide a manually engageable control lever device for vehicles having handlebar-type steering that includes at least one handle grip and structure for mounting the device, the device having a main body mountable at the structure and adjacent to the handle grip, said main body having at least a first flare extending therefrom and adapted for secure engagement by either a user's finger or thumb to cause movement from a variety of user hand positions or angles at the handle grip once the main body is mounted, the main body configured so that the flare is oriented convergently relative to the handle grip once the main body is mounted, with a substantial but variable space defined between the flare and the handle grip during operation of the device.

It is still another object of this invention to provide a device for modifying a manually accessible surface area of a motorized vehicle control lever having a distal end and movable toward and away from a handle grip of the vehicle in a plane defined between the handle grip and the control lever, the device including a main body with a portion adapted to be mounted at the control lever, a first flare extending from the portion and adapted for secure engagement by either a user's finger or thumb for lever movement from a variety of user hand positions or angles once the device is mounted, the portion of the main body contoured to fit the control lever so that the flare extends in a direction substantially normal to the plane of control lever movement.

It is yet another object of this invention to provide a method of modification of a digitally accessible surface of a manual control lever for a vehicle having handlebar-type steering that includes at least one handle grip, the lever having a distal end and movable, when mounted, toward and away from the handle grip in a plane defined between the handle grip and the control lever, the method including the steps of defining at least first and second areas of the digitally accessible surface of the control lever, and extending at least one of the areas of the digitally engagable surface of the control lever in a direction substantially normal to the plane of control lever movement.

With these and other objects in view, which will become apparent to one skilled in the art as the description proceeds, this invention resides in the novel construction, combination, and arrangement of parts and method substantially as hereinafter described, and more particularly defined by the appended claims, it being understood that changes in the precise embodiment of the herein disclosed invention are meant to be included as come within the scope of the claims.

### BRIEF DESCRIPTION OF THE DRAWINGS

The accompanying drawings illustrate a complete embodiment of the invention according to the best mode so far devised for the practical application of the principles thereof, and in which:

FIG. 1 is a perspective view of a first embodiment of a control lever device of this invention in use with a throttle mechanism;

FIG. 2 is a perspective of the device of FIG. 1;

FIG. 3 is a perspective view of a second embodiment of the device of this invention mounted to a conventional thumb or finger activated control lever;

FIG. 4 is an exploded view of the device of FIG. 3 and the control lever; and

FIGS. 5 through 8 are perspective views illustrating use of the devices of this invention (the device of FIG. 1 is shown, though use is the same for either embodiment).

### DESCRIPTION OF THE INVENTION

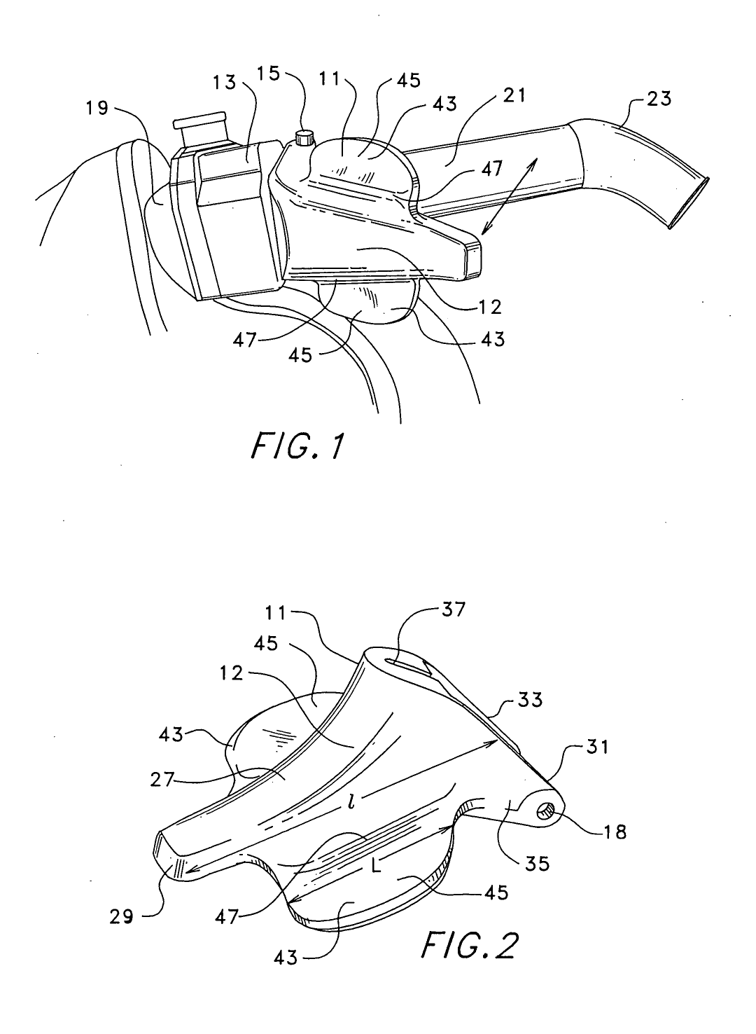

This description will illustrate different embodiments of the device of this invention which may be utilized with a wide variety of finger or thumb operable (manual) controls and control levers for various types of vehicles (such as all terrain vehicles, motor cycles and motor bikes, personal watercraft, snowmobiles and the like). The devices of this invention are particularly shown herein in conjunction with throttles and throttle levers of the type found on snowmobiles though their applicability is broader. Such control levers are typically found on motor vehicles having handlebar-type steering assemblies including handle grips, and have a distal end spaced from a mounting end. These control levers are movable (pivotable) toward and away from a handle grip in a plane defined between the handle grip and the control lever (see FIG. 1).

FIGS. 1 and 2 show a first embodiment of the device of this invention for original equipment manufacture or for use as a replacement part. Modified form control lever 11 of this invention includes a main body 12 pivotably mounted at snowmobile control lever body structure 13 by a pivot pin assembly (including pin 15 and retainer 17, for example, as shown in FIG. 4 and as is known for use with such throttle levers) through pivot connections (openings 18). Lever 11 is manually pivotable to operate, for example, a throttle cable-type actuator (not shown). Control lever body structure 13 is mounted on handlebar-type steering assembly 19 adjacent to handle grip 21 at one distal end 23 thereof.

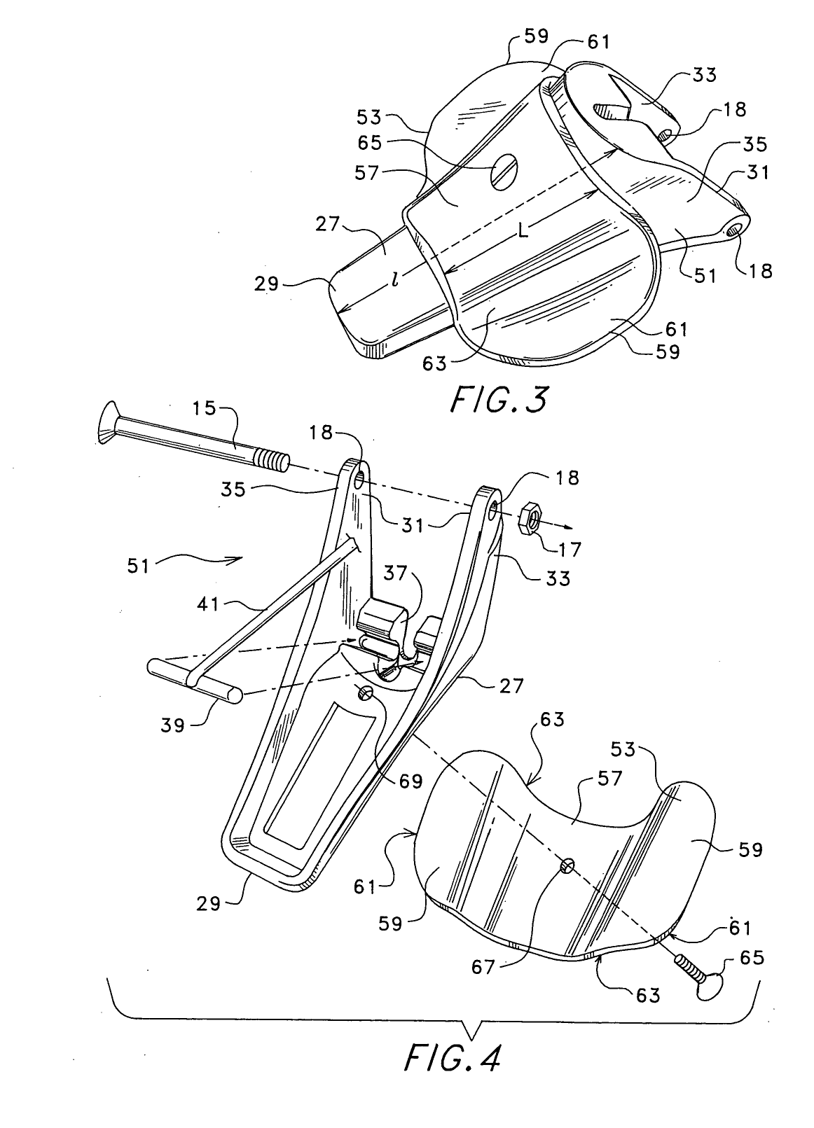

Lever main body 12 is similar in many regards to known control levers having a standard configuration (as shown in FIGS. 3 and 4) except as noted herein. The standard configuration includes central portion 27 of main body 12 having a distal end 29 and a mounting end 31. The standard configuration includes connecting wings 33 and 35 adapted for the pivoting connection at body structure 19, the wings spaced from one another. Standard configuration biasing connection is accommodated by main body structure 37 adapted for receipt of pin 39 connected to biased actuator cable 41 (see FIG. 4).

The standard configuration is modified in accord with this invention by the extension of at least one of plural defined areas of the digitally accessible surface of the standard configuration control lever. At least one flare 43 (a lateral surface extension) is formed at main body 12 extending from portion 27. Two flares 43 are preferred each extending from portion 27 opposite portion 27 from one another. The overall length of main body 12 (l in FIG. 2) exceeds the length (L in FIG. 2) of flares 43, flares 43 positioned intermediate ends 29 and 31 of main body 12 so that distal end 29 of main body 12 remains prominent and readily manually engageable. As shown in FIG. 1, flares 43 provide enhanced surface area characteristics including a surface extension 45 of a size selected for secure engagement by either a user's finger or thumb to cause movement of lever 11 from a variety of user hand positions or angles at handle grip 21, and a digitally engageable cradle 47 established between each surface 45 of flares 43 and central portion 27 of main body 12.

Main body 12 is configured so that flares 43 are oriented convergently relative to handle grip 21 once lever 11 is mounted, with a substantial but variable space defined between flares 43 and handle grip 21 during operation of the device, the flares extending in a direction substantially normal to the plane of throttle lever movement (see FIG. 1).

A second embodiment of the device of this invention is shown in FIGS. 3 and 4 for application to an existing control lever 51 of standard configuration (as described above and as shown in FIGS. 3 and 4). As may be appreciated, this embodiment of the device may be mounted to control lever 51 without removal of the control lever from the vehicle. Manually accessible surface area modification attachment 53 includes main body 55 having a portion 57 contoured for mounting to the existing lever structure 51. At least one flare 59 (and, as before, preferable two flares 59) extend from portion 57 (opposite one another relative to the central portion 51 in the case of dual flares 59). Portion 57 is contoured to fit control lever 51 so that the flares extend in a direction substantially normal to the plane of lever movement (the same as shown in FIG. 1). Flares 59 provide the same enhanced surface area characteristics as discussed above with respect to lever 11 (i.e., a surface extension 61 of a size selected for secure engagement by either a user's finger or thumb to cause movement of lever 51 from a variety of user hand positions or angles at handle grip 21, and a digitally engageable cradles 63).

Attachment 53 includes mounting screw 65 (and a matable nut—not shown) engageable at opening 67 to secure attachment 53 to lever 51 (at opening 69 made through lever 51). Any other type of suitable attachment could be utilized. Length (L in FIG. 3) of attachment 53 is preferably less than overall length (l in FIG. 3) of lever 51 between ends 29 and 31, attachment 53 preferably located between ends 29 and 31 so that distal end 29 remains prominent.

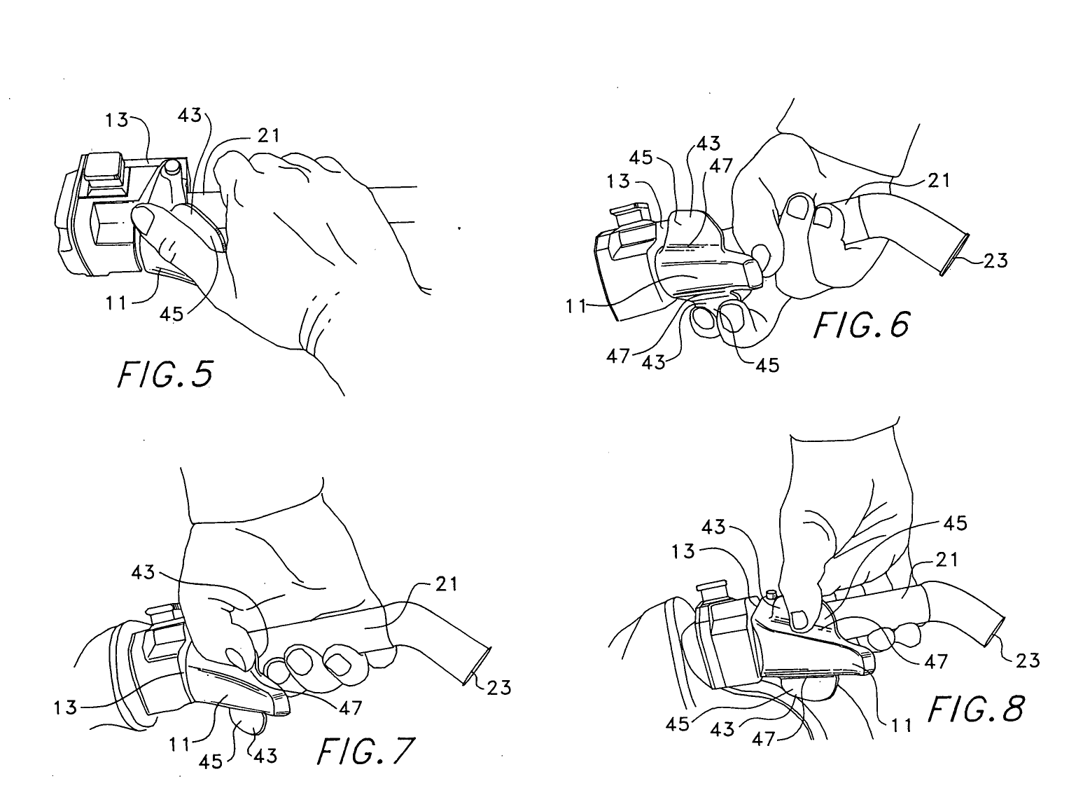

FIGS. 5 through 8 illustrate the flexibility of control lever operation provided an operator of a vehicle having the device of this invention mounted thereto, allowing lever manipulation from a variety of hand positions and angles relative to handle grip 21, and thereby freeing the operator to move relative to the vehicle as may be necessitated by conditions. These illustrations show use of lever 11 shown in FIGS. 1 and 2, though the same utilization principles apply where attachment 53 is utilized. In either case, digital (thumb or finger) engagement at surface extension 45 and/or cradle 47 of flares 45 enhances operation of the control lever independent of an operator's body position relative to the control.

As may be appreciated from the foregoing, improved user access to motorized vehicle control levers is provided by extension of at least one area of the digitally engageable surface of the control lever in a direction substantially normal to the plane of control lever movement as defined herein. The device of is invention may be made of plastic materials commonly utilized to make the control levers themselves (and using any known forming or molding technique), or may be made of any other material suitable to the task. While dual flares are shown, it should be realized that devices of either embodiment type shown herein (and in accord with this invention) could be manufactured having only one or the other of the top and bottom flares.

1. A manually engageable control lever device for vehicles having handlebar-type steering that includes at least one handle grip and structure for mounting said device, said device comprising:
a main body mountable at the structure and adjacent to the handle grip, said main body having at least a first flare extending therefrom and adapted for secure engagement by either a user's finger or thumb to cause movement from a variety of user hand positions or angles at the handle grip once said main body is mounted, said main body configured so that said flare is oriented convergently relative to the handle grip once said main body is mounted, with a substantial but variable space defined between said flare and the handle grip during operation of said device.

2. The device of claim 1 wherein said main body includes a second flare extending from a central portion of said main body opposite said central portion from said first flare and adapted for secure engagement by either a user's finger or thumb to cause movement.

3. The device of claim 1 wherein said first flair has a length and wherein said main body has an overall length exceeding said length of said first flare.

4. The device of claim 3 wherein said main body has opposite ends, and wherein said first flair is positioned along said main body length intermediate said ends of said main body.

5. The device of claim 4 wherein said main body includes a second flare extending from a central portion of said main body intermediate said ends and opposite said central portion from said first flare, and wherein said second flare and one of said ends of said main body are adapted for secure manual engagement to cause movement.

6. The device of claim 1 wherein said first flare of said main body defines a surface area characteristic including a digitally engageable cradle and a digitally engagable extension surface.

7. The device of claim 1 wherein said main body includes pivot connecting structure for pivotable connection of said main body to the structure.

8. The device of claim 7 wherein the vehicles are snowmobiles and wherein said main body includes engageable structure for actuator connection with said main body.

9. A device for modifying a manually accessible surface area of a motorized vehicle control lever having a distal end and movable toward and away from a handle grip of the motorized vehicle in a plane defined between the handle grip and the control lever, said device comprising a main body including a portion adapted to be mounted at the control lever, a first flare extending from said portion and adapted for secure engagement by either a user's finger or thumb for lever movement from a variety of user hand positions or angles once said device is mounted, said portion of said main body contoured to fit the control lever so that said flare extends in a direction substantially normal to the plane of control lever movement.

10. The device of claim 9 wherein said portion of said main body is of a length selected so that the distal end of the control lever remains manually engageable after said device is mounted.

11. The device of claim 9 wherein said main body includes a second flare extending from said portion opposite said portion from said first flare and adapted for secure manual engagement by a user.

12. The device of claim 9 wherein said first flare and said portion of said main body define a surface area characteristic including a digitally engageable cradle and a digitally engagable extension surface.

13. The device of claim 9 further comprising a mounting unit, and wherein said portion includes an engageable structure for receiving said mounting unit.

14. A method of modification of a digitally accessible surface of a manual control lever for a vehicle having handlebar-type steering that includes at least one handle grip, the lever having a distal end and movable, when mounted, toward and away from the handle grip in a plane defined between the handle grip and the control lever, the method comprising the steps of:
defining at least first and second areas of the digitally accessible surface of the control lever; and
extending at least one of said areas of the digitally engagable surface of the control lever in a direction substantially normal to the plane of control lever movement.

15. The method of claim 14 wherein the step of defining includes defining a third area, and wherein the step of extending includes extending at least two of said areas in said direction.

16. The method of claim 15 further comprising the step of leaving the distal end of the control lever digitally accessible between said at least two areas.

17. The method of claim 14 further comprising establishing a cradle between said areas.

18. The method of claim 14 further comprising practicing said method with either one of an original equipment control lever or a replacement control lever for the vehicle.

19. The method of claim 14 further comprising practicing said method with a control lever already mounted at the vehicle.
